(19) United States
(12) Patent Application Publication
(10) Pub. No.: US 2025/0208002 A1
(43) Pub. Date: Jun. 26, 2025

(54) SYSTEM AND METHOD TO DETERMINE DEFECTIVENESS OF A MATTRESS

(71) Applicant: Kyle Johansen, Ham Lake, MN (US)

(72) Inventor: Kyle Johansen, Ham Lake, MN (US)

(21) Appl. No.: 18/395,830

(22) Filed: Dec. 26, 2023

(51) Int. Cl. G01M 99/00; B68G 15/00

(52) U.S. Cl. CPC G01M 99/001; B68G 15/00

(57) ABSTRACT

A measurement device is configured to measure a defectiveness of a mattress. The measurement device may include a base plate having a top surface and a bottom surface. The measurement device may include a guide member disposed on the top surface of the base plate. The guide member may include a scale configured to measure the defectiveness of a mattress.

### BACKGROUND

### Field

The present disclosure generally relates to mattress testing systems, and more particularly to a system and method to determine defectiveness of a mattress.

### Description of the Related Art

Typically, a mattress is deemed defective by a manufacturer if the mattress has excessive sagging or dipping. When there exists excessive sagging or dipping, the mattress may be covered under warranty claims. Many consumers face difficulty in determining whether the mattress is faulty/defective, and/or to prove that the mattress is faulty/defective as it is very subjective to determine whether the mattress has excessive sagging or dipping.

Thus, there exists a need for a system and method that may assist a consumer in determining if the mattress is defective and/or if the mattress has excessive sagging or dipping.

### SUMMARY

The following presents a simplified summary of the present disclosure in a simplified form as a prelude to the more detailed description that is presented herein.

In accordance with embodiments of the disclosure, there is provided a measurement device configured to measure a defectiveness of a mattress. The measurement device may include a base plate having a top surface and a bottom surface. The measurement device may further include a guide member disposed on the top surface of the base plate. The guide member may include a scale configured to measure the defectiveness of a mattress.

In some aspects, the guide member may be pivotally connected to the base plate and configured to move between a first position and a second position. In some aspects, the top surface may include a recess, and the guide member may be configured to be inserted into the recess in the first position.

In some aspects, a plane of the guide member may be parallel to a plane of the base plate in the first position. In further aspects, the plane of the guide member may be perpendicular to the plane of the base plate in the second position.

The present disclosure discloses a measuring device that facilitates a consumer to determine whether a mattress is defective or not. Stated another way, the device may facilitate the consumer to determine a depression in the mattress. The measuring device may accurately and easily determine the depression in the mattress, thus enhancing consumer convenience.

These and other features, aspects, and advantages of the present disclosure will become better understood with reference to the following description and appended claims.

### BRIEF DESCRIPTION OF THE DRAWINGS

Illustrative embodiments of the present disclosure are described herein with reference to the accompanying drawings, in which:

FIG. 1 depicts a top perspective view of a defectiveness measurement device in a closed state in accordance with the present disclosure.

FIG. 2 depicts a top perspective view of a defectiveness measurement device in an open state in accordance with the present disclosure.

FIG. 3 depicts a side elevation view of a defectiveness measurement device in accordance with the present disclosure.

FIG. 4 depicts a perspective view of a defectiveness measurement device in an in-use orientation in accordance with the present disclosure.

FIG. 5 depicts a detailed perspective view of the defectiveness measurement device of FIG. 4 in accordance with the present disclosure.

### DETAILED DESCRIPTION OF DISCLOSURE

For a further understanding of the nature and function of the embodiments, reference should be made to the following detailed description. Detailed descriptions of the embodiments are provided herein, as well as, the best mode of carrying out and employing the present disclosure. It will be readily appreciated that the embodiments are well adapted to carry out and obtain the ends and features mentioned as well as those inherent herein. It is to be understood, however, that the present disclosure may be embodied in various forms. Therefore, persons of ordinary skill in the art will realize that the following disclosure is illustrative only and not in any way limiting, as the specific details disclosed herein provide a basis for the claims and a representative basis for teaching to employ the present disclosure in virtually any appropriately detailed system, structure or manner. It should be understood that the devices, materials, methods, procedures, and techniques described herein are presently representative of various embodiments. Other embodiments of the disclosure will readily suggest themselves to such skilled persons having the benefit of this disclosure.

Reference will now be made in detail to the present preferred embodiments of the disclosure, examples of which are illustrated in the accompanying drawings. Wherever possible, the same reference numerals are used in the drawings and the description to refer to the same or like parts.

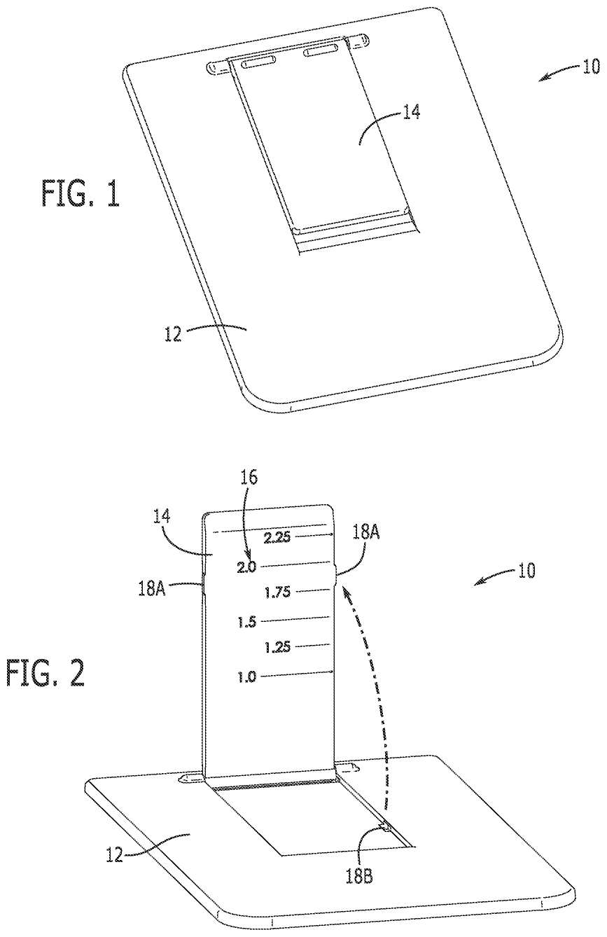

FIG. 1 depicts a top perspective view of a defectiveness measurement device 10 (or measurement device 10) in a closed state in accordance with the present disclosure. FIG. 1 will be described in conjunction with FIGS. 2-5.

The measurement device 10 may include a base plate 12 having a top surface and a bottom surface. The base plate 12 may be of any shape including, but not limited to, rectangular, square, circular, elliptical, and/or the like. The base plate 12 may be of any dimension. For example, the base plate 12 may have a length in a range of 4 to 6 inches and a width in a range of 2 to 4 inches.

The measurement device 10 may further include a guide member 14 (or guide plate 14) that may include a scale 16 (or any other measurement indicating member) configured to measure defectiveness of a mattress 20A. Stated another way, the scale 16 may be configured to measure sagging or depression 20B of the mattress 20A, and indicate the sagging or depression 20B on the mattress 20A. For example, the guide member 14 may include markings (as depicted in FIG. 2) that may indicate the level of sagging or depression 20B on the mattress 20A. The guide member 14 may be of any shape including, but not limited to, rectangular, circular, elliptical, and/or the like. The guide member 14 may be of any dimension. For example, the guide member 14 may have a length in a range of 2 to 3 inches and a width in a range of 0.5 to 1.5 inches.

In some aspects, the guide member 14 may be a part of the base plate 12. Stated another way, the guide member 14 may be integrated to the base plate 12. Alternatively, the guide member 14 may be an external component that may be removably attached to the base plate 12. For example, the base plate 12 and the guide member 14 may be two separate components that may snap with each other to attach the base plate 12 with the guide member 14.

In some aspects, the guide member 14 may be pivotally connected to the base plate 12. For example, the guide member 14 may be pivotally connected to an edge of the base plate 12. Stated another way, the guide member 14 may be hinged at the edge of the base plate 12 (or hinged in proximity to the edge of the base plate 12). In further aspects, the guide member 14 may be located at a center portion of the base plate 12.

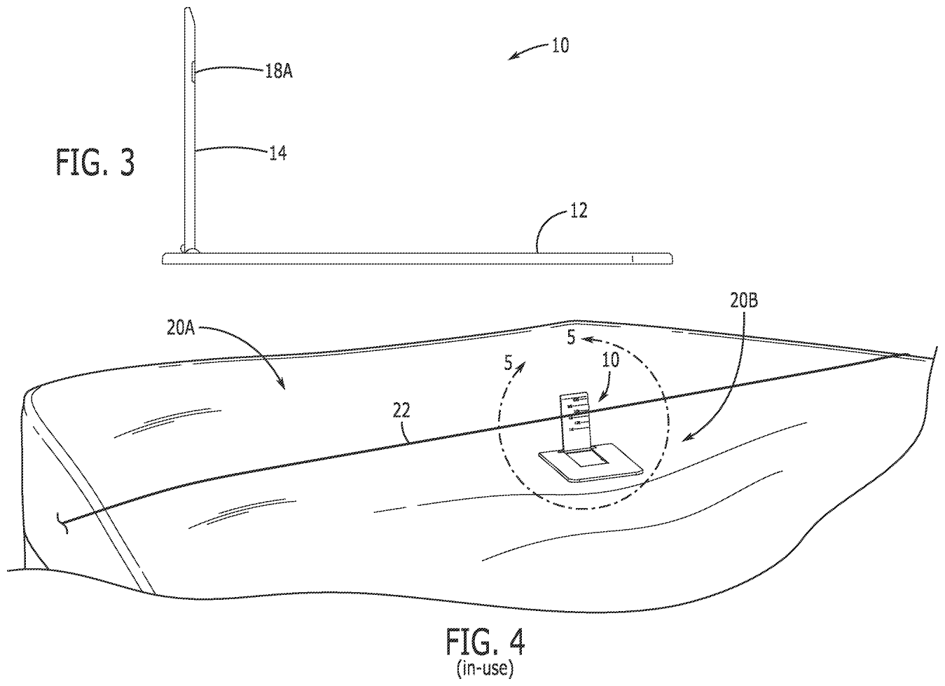

The guide member 14 may be configured to move between a first position and a second position. In the first position, a plane of the guide member 14 may be parallel to a plane of the base plate 12. Stated another way, the measurement device 10 (or the guide member 14) may be in a closed state when the guide member 14 may be in the first position. In the second position, as illustrated in FIG. 3, the plane of the guide member 14 may be perpendicular to the plane of the base plate 12 (or at any other angle relative to the base plate 12). Stated another way, the measurement device 10 (or the guide member 14) may be in an open state when the guide member 14 may be in the second position.

In some aspects, the base plate 12 may include a recess (or a cavity) on the top surface of the base plate 12. The recess may be located at a center portion of the base plate 12. In some aspects, the recess may be located in proximity to an edge of the base plate 12. In some aspects, the guide member 14 may be disposed in the recess of the base plate 12. Stated another way, the guide member 14 is configured to be inserted into the recess. The guide member 14 may completely lay inside the recess when the measurement device 10 may be in the closed state. In some aspects, the dimensions of the recess may correspond to the dimensions of the guide member 14. For example, the depth of the recess may be equivalent to a thickness of the guide member 14. In the first position, the guide member 14 may be inserted inside the recess. In the second position, the plane of the guide member 14 may be outside the recess (and is in the open state).

In alternative aspects, the base plate 12 may include a slot that may be disposed in the base plate 12, instead of the recess described above. The slot may be disposed in the center portion, may be in proximity to the edge of the base plate 12. The slot may be configured to receive the guide member 14. The location and dimensions of the slot may correspond to the location and dimension of the guide member 14. In the first position, the guide member 14 may be inside the slot. In the second position, the plane of the guide member 14 may be outside the slot.

In some aspects, the measuring device 10 may include a locking mechanism that may be configured to lock the guide member 14 to the base plate 12. For example, the guide member 14 may include a locking tab 18A and the base plate 12 may include a tab recess 18B that may be configured to receive the locking tab 18A to facilitate locking of the guide member 14 with the base plate 12 (e.g., in the first position). In some aspects, the locking tab 18A may be positioned on a side surface of the guide member 14. For example, the locking tab 18A may be positioned on a top side of the guide member 14. In further aspects, the tab recess 18B may be positioned corresponding to the position of the locking tab 18A.

In further aspects, the guide member 14 may include a protrusion and the base plate 12 may include a slot that may be configured to receive the protrusion, which may facilitate locking of the guide member 14 with the base plate 12. In alternative aspects, the guide member 14 may be locked with the base plate 12 via any other mechanism.

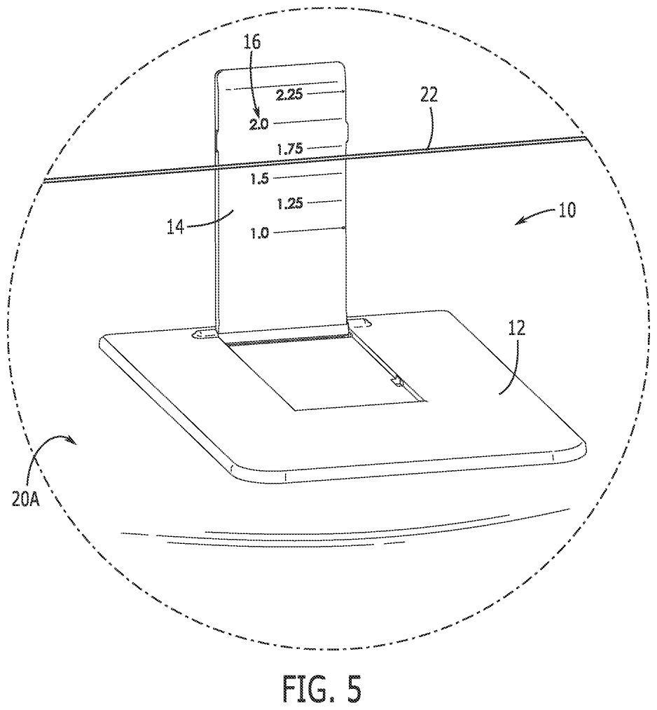

In operation, the consumer may position the measuring device 10 on the mattress 20A to determine the depression 20B in the mattress 20A. For example, the consumer may position the measuring device 10 in the center portion of the mattress 20A where the depression 20B may be the highest. The consumer may then move the guide member 14 from the first position to the second position (or from the closed state to the open state) to measure the depression 20B. Stated another way, the consumer may lift the guide member 14 from the recess or slot associated with the base plate 12, to use the guide member 14 for measuring the depression 20B. The consumer may then use a measurement verification string 22 (as depicted in FIGS. 4-5) to accurately determine the depression 20B by using the guide member 14. For example, the measurement verification string 22 may lay across the entire mattress 20A, and facilitate the consumer to read the marking on the scale (or the guide member 14). In addition or alternatively, the consumer may use any other method to read the marking including, but not limited to, board, string with washers, or other straight edged tools to lay across the entirely of the mattress 20A. The consumer may then see exactly how deep the impression is in the mattress 20A.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This disclosure is susceptible to considerable variation within the spirit and scope of the appended claims.

The claimed disclosure is:

1. A measurement device comprising:
a base plate having a top surface and a bottom surface; and
a guide member disposed on the top surface of the base plate, wherein the guide member comprises a scale configured to measure a defectiveness of a mattress.

2. The measurement device of claim 1, wherein the guide member is pivotally connected to the base plate and configured to move between a first position and a second position.

3. The measurement device of claim 2, wherein a plane of the guide member is parallel to a plane of the base plate in the first position.

4. The measurement device of claim 2, wherein a plane of the guide member is perpendicular to a plane of the base plate in the second position.

5. The measurement device of claim 2, wherein the top surface comprises a recess.

6. The measurement device of claim 5, wherein the guide member is configured to be inserted inside the recess in the first position.

7. A measurement device comprising:
a base plate having a top surface and a bottom surface; and
a guide member disposed on the top surface of the base plate, wherein the guide member comprises a scale configured to measure a defectiveness of a mattress, and wherein the guide member is pivotally connected to the base plate and configured to move between a first position and a second position.

8. The measurement device of claim 7, wherein a plane of the guide member is parallel to a plane of the base plate in the first position.

9. The measurement device of claim 7, wherein a plane of the guide member is perpendicular to a plane of the base plate in the second position.

10. The measurement device of claim 7, wherein the top surface comprises a recess.
